(19) United States
(12) Patent Application Publication
(10) Pub. No.: US 2026/0112731 A1
(43) Pub. Date: Apr. 23, 2026

(54) TEMPERATURE CONTROL SYSTEM

(71) Applicant: Mahle Internatiional GmbH, Stuttgart (DE)

(72) Inventors: Ulrich Maucher, Korntal-Münchingen (DE); Nicolas Ferrand, Stuttgart (DE); Friedrich Brotz, Reutlingen (DE); Jens Richter, Grossbottwar (DE)

(21) Appl. No.: 19/366,455

(22) Filed: Oct. 22, 2025

(30) Foreign Application Priority Data
Oct. 23, 2024 (DE) 102024130887.7

(51) Int. Cl. H01M 10/6554; H01M 10/613; H01M 10/625

(52) U.S. Cl. CPC H01M 10/6554; H01M 10/613; H01M 10/625

(57) ABSTRACT

A temperature-controlling system for controlling the temperature of at least three components via a temperature-controlling agent is disclosed. The system includes a system inlet for supplying the temperature-controlling agent, a system outlet for discharging the temperature-controlling agent, and at least three components to be temperature-controlled. Each component has a component inlet for supplying the temperature-controlling agent and a component outlet for discharging the temperature-controlling agent from the respective component. The system inlet is fluidically connected to at least two component inlets. The system outlet is fluidically connected to at least one component outlet. The at least three components are fluidically interconnected according to a circuit diagram such that a number of components fluidically connected in parallel with regard to the temperature-controlling agent is greater at the system inlet than at the system outlet.

### CROSS-REFERENCE TO RELATED APPLICATIONS

This application claims priority to Germany Patent Application No. DE 102024130887.7 filed on Oct. 23, 2024, the contents of which is hereby incorporated by reference in its entirety.

### TECHNICAL FIELD

The present invention relates to a temperature-controlling system for controlling the temperature of at least three components by means of a temperature-controlling agent.

### BACKGROUND

Preferably, but without limiting the generality, such a temperature-controlling system may be a battery system comprising several battery modules as components, each of which in turn comprises several electrochemical battery cells. In particular, the temperature-controlling system may be a temperature-controlled traction battery for a battery-powered electric vehicle.

Heating the battery cells may be necessary to charge the traction battery. Similarly, at low ambient temperatures, it may be necessary to heat the battery cells, at least when starting to drive, in order to enable efficient power output. Furthermore, cooling of the battery cells may be necessary during power delivery and also during charging. Heating and cooling each represent a form of temperature control. To regulate the temperature of the traction battery, a temperature-controlling system is formed using the battery modules, in which the battery cells or battery modules are temperature-controlled using a temperature-controlling agent.

Efficient temperature control is particularly important in vehicle applications, so that the temperature-controlling system or the temperature-controlled traction battery requires as little installation space and weighs as little as possible.

The present invention addresses the problem of providing an improved or at least different embodiment for such a temperature-controlling system, which is characterized in particular by high efficiency.

The invention solves this problem by the subject matter of the independent claim(s). Advantageous embodiments are the subject-matter of the dependent claims.

### SUMMARY

The invention is based on the general idea of arranging the components to be temperature-controlled with regard to their exposure to the temperature-controlling agent within the temperature-controlling system in such a way that the number of components exposed to the temperature-controlling agent in parallel when flowing through the temperature-controlling system is proportional to the temperature control capacity of the temperature-controlling agent. In other words, more components are exposed to the temperature-controlling agent in parallel at a system inlet than at a system outlet. The invention is based on the realization that the temperature-controlling agent has the greatest temperature control capacity at the system inlet, while the smallest temperature control capacity is found at the system outlet. The heat transfer performance depends on the temperature difference and the flow velocity of the temperature-controlling agent. The greatest temperature difference between the temperature-controlling agent and the components to be temperature-controlled occurs at the system inlet. As the temperature control progresses, this temperature difference inevitably decreases. In order to achieve sufficient temperature control or temperature control performance even at reduced temperature differences, the flow velocity of the temperature-controlling agent can be increased accordingly. This is achieved in the invention by reducing the number of components through which the flow passes in parallel along the flow path of the temperature-controlling system, which inevitably increases the flow velocity of the temperature-controlling agent at the individual components. As a result, the temperature-controlling agent flows relatively slowly within the temperature-controlling system in the area of the system inlet, while it flows relatively quickly in the area of the system outlet. The low flow velocity, combined with the high temperature difference, results in a sufficiently high temperature control performance. Similarly, the high flow velocity in combination with the reduced temperature difference also results in sufficient temperature control performance. In this context, applying a temperature-controlling agent to a component can mean heat transfer coupling of the respective components with the temperature-controlling agent and/or an inflow and outflow or a supply and discharge of the temperature-controlling agent to and from the respective component and/or a flow around or through the respective component with the temperature-controlling agent.

The components to be temperature-controlled can be configured similarly with regard to the tempering requirements and, in particular, can be designed identically. In vehicle applications, the components may conveniently be battery modules of a traction battery, which conveniently have similar and preferably identical temperature control requirements. In particular, these battery modules may be designed identically.

Specifically, the invention proposes a temperature-controlling system that serves to control the temperature of at least three identical components by means of a temperature-controlling agent and, for this purpose, has a system inlet for supplying the temperature-controlling agent to the temperature-controlling system, a system outlet for discharging the temperature-controlling agent from the temperature-controlling system, and at least three identical components to be temperature-controlled. Each component has a component inlet for supplying the temperature-controlling agent to the respective component and a component outlet for discharging the temperature-controlling agent from the respective component.

Within the temperature-controlling system, the system inlet is fluidically connected to at least two component inlets, while the system outlet is fluidically connected to at least one component outlet. The essential feature of the invention is that, within the temperature-controlling system, the components are connected fluidically in accordance with a circuit diagram in such a way that the number of components fluidically connected in parallel with regard to the temperature-controlling agent is greater at the system inlet than at the system outlet. In order to achieve the desired effect of a temperature control performance that is as constant as possible for all components from the system inlet to the system outlet, it may be advisable to use the entire flow of the temperature-controlling agent from the system inlet to the system outlet to control the temperature of the components, so that, in particular, no bypasses are provided within the temperature-controlling system to circumvent individual components. It is also important that the components to be temperature-controlled in parallel are designed similarly, so that they have comparable temperature control requirements.

According to an advantageous embodiment, the number of components fluidically connected in parallel with regard to the temperature-controlling agent at the system inlet can be 1.5 to 5 times, in particular 1.5 to 4 times, preferably 2 to 3.5 times, greater than at the system outlet. Tests and/or calculations have shown that under these conditions, a particularly favorable effect can be achieved in terms of homogenizing the temperature control performance across the entire temperature-controlling system.

According to an advantageous embodiment, the temperature-controlling system may have four or more identical components to be temperature-controlled. At least two components can then be connected fluidically in series at the system outlet with regard to the temperature-controlling agent, wherein the system outlet is fluidically connected to only one component outlet. In other words, a parallel connection of at least two components is implemented at the system inlet, while a series connection of at least two components is implemented at the system outlet, which inevitably results in the flow velocity of the temperature-controlling agent being significantly higher at the system outlet than at the system inlet.

According to another advantageous embodiment, it may be provided that the number of components fluidically connected in parallel with regard to the temperature-controlling agent does not increase from the system inlet to the system outlet, but remains constant or decreases, thus decreasing overall. This does not rule out the possibility that, particularly at the system inlet, two or more consecutive groups or rows of components subjected to parallel loads may have a constant number. However, the number decreases on the way to the system outlet. This consistently implements the principle of the invention, according to which the temperature difference of the temperature-controlling agent, which decreases from the system inlet to the system outlet, can be compensated for by increasing the flow velocity of the temperature-controlling agent.

According to a further advantageous embodiment, it may be provided that several components fluidically connected in parallel with regard to the temperature-controlling agent form a parallel group, with at least two parallel groups connected in series. This allows a comparatively large number of components to be uniformly treated with the temperature-controlling agent.

In accordance with an advantageous further development, it may be provided that at least two identical parallel groups, in which the number of components fluidically connected in parallel with regard to the temperature-controlling agent is the same, are fluidically connected in series with regard to the temperature-controlling agent. This means that the number of components through which flow passes in parallel does not decrease continuously, but rather in stages. This simplifies the design of the temperature-controlling system.

In accordance with another further development, it may be provided that at least two unequal parallel groups, in which the number of components fluidically connected in parallel with regard to the temperature-controlling agent is different, are fluidically connected in series with regard to the temperature-controlling agent, wherein the number of components fluidically connected in parallel with regard to the temperature-controlling agent is greater in the upstream parallel group than in the downstream parallel group. This reduces the number of components connected in parallel in the direction of flow.

In another embodiment, the system inlet may be fluidically connected to one of the parallel groups, while the system outlet is fluidically connected to a series group in which several of the components are fluidically connected in series with regard to the temperature-controlling agent. In particular, the system outlet is fluidically connected precisely to a single series group and thus ultimately to precisely one component, namely the component in the series group that is last to be acted upon by the temperature-controlling agent. This also ensures that more components are exposed to the temperature-controlling agent at the system inlet with a significantly reduced flow velocity, while only individual components are exposed to the temperature-controlling agent at the system outlet with a significantly higher flow velocity.

According to an advantageous embodiment, the temperature-controlling system may have a system housing that has the system inlet and the system outlet and in which the components are arranged. Conveniently, the system housing may have a channel system that fluidically connects the system inlet to the system outlet for guiding the temperature-controlling agent, which fluidically connects the component inlets and the component outlets to each other in accordance with the circuit diagram. With the help of the channel system, the more or less complex circuit diagram for the flow through the temperature-controlling system with the temperature-controlling agent presented here can be easily implemented.

The channel system may conveniently have several connection points for fluidic connection to the component inlets and component outlets. These connection points, the component inlets, and the component outlets can be coordinated with each other in such a way that they form plug connections, so that by plugging the component inlets and the component outlets into the connection points, fluidic connections are established between the connection points and the component inlets and the component outlets. This makes the temperature-controlling system particularly easy to set up. In particular, the system housing can be easily equipped with components that are then fluidically connected to the channel system in accordance with the circuit diagram. For example, the channel system can be formed in a base plate of the system housing on which the components are positioned, in particular plugged in.

A configuration in which the respective component is a battery module comprising several electrochemical battery cells is particularly advantageous. The temperature-controlling system is then a temperature-controlled battery system, preferably a temperature-controlled traction battery.

In this context, “configuration” corresponds to “design” and/or “setup,” so that the phrase “configured so that” is synonymous with the phrase “designed so that” and/or “set up so that”.

According to a first alternative, it may be expedient for the respective battery module to have a temperature control plate through which the temperature-controlling agent can flow, which has the respective component inlet and the respective component outlet and to which the battery cells of the respective battery module are connected for heat transfer. This results in a particularly simple design for the temperature-controlling system.

According to a second alternative, however, it may be provided that the respective battery module has a module housing through which the temperature-controlling agent can flow, which has the respective component inlet and the respective component outlet and in which the battery cells are arranged in such a way that they come into direct contact with the temperature-controlling agent. This provides the battery cells with what is known as immersion cooling, which is characterized by particularly high heat transfer performance.

Further important features and advantages of the invention are apparent from the subclaims, the drawings, and the accompanying description of the figures based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a setup, an apparatus, or an arrangement, which are designated separately, can form separate parts or components of this unit or be integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in

FIG. 1 an isometric view of a temperature-controlling system for controlling the temperature of multiple components,

FIG. 2 an isometric view of the temperature-controlling system with a simplified representation of the components.

### DETAILED DESCRIPTION

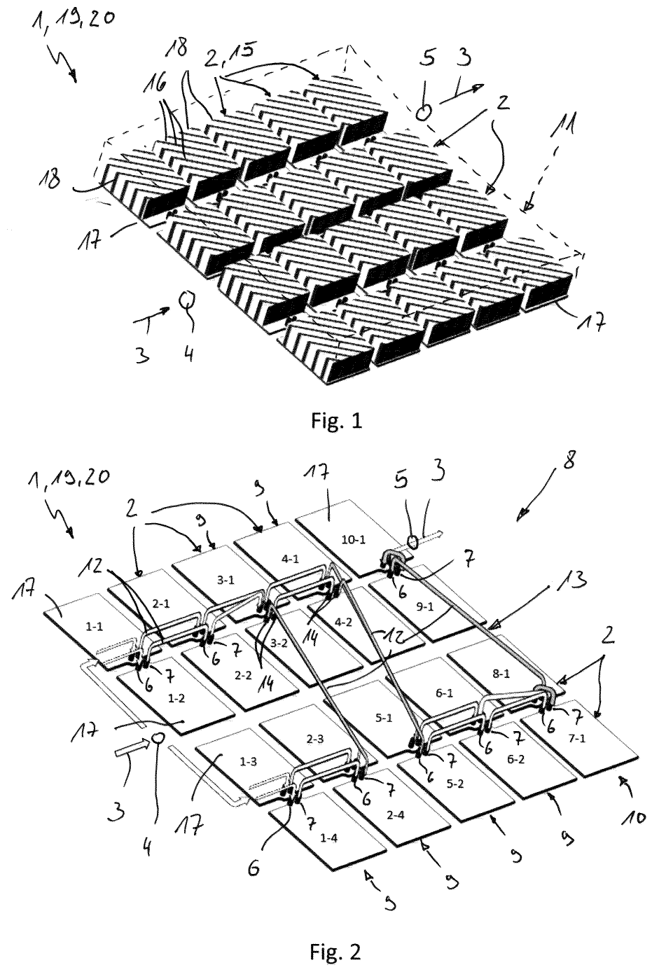

According to FIGS. 1 and 2, a temperature-controlling system 1, which serves to control the temperature of at least three, in particular similar, preferably identical, components 2 by means of a coolant 3 represented by arrows, comprises a system inlet 4 for supplying the temperature-controlling agent 3 to the temperature-controlling system 1, a system outlet 5 for discharging the temperature-controlling agent 3 from the temperature-controlling system 1, and several, namely at least three, components 2 to be temperature-controlled. Without limiting the generality, the example shown includes twenty identical components 2, which are also arranged in a checkerboard pattern for illustrative purposes only. Each component 2 has a component inlet 6 for supplying the temperature-controlling agent 3 to the respective component 2 and a component outlet 7 for discharging the temperature-controlling agent 3 from the respective component 2. In FIG. 2, some of the component inlets 6 and some of the component outlets 7 are provided with reference symbols.

According to FIG. 2, the system inlet 4 is fluidically connected to at least two component inlets 6. In the example shown, system inlet 4 is fluidically connected to exactly four component inlets 6. The system outlet 5 is fluidically connected to at least one component outlet 7. In the example shown in FIG. 2, the system outlet 5 is fluidically connected to exactly one component outlet 7. Within the temperature-controlling system 1, the components 2 are connected fluidically to each other in accordance with a circuit diagram 8. This circuit diagram 8 may show fluidic series connections and/or fluidic parallel connections of the components 2 with regard to the temperature-controlling agent 3. In circuit diagram 8, all components 2 of the temperature-controlling system 1 are connected fluidically to each other in such a way that temperature-controlling agent 3 is supplied to all components 2 and then discharged from them again. In the temperature-controlling system 1 presented here, circuit diagram 8 is configured such that the number of components 2 fluidically connected in parallel with regard to the temperature-controlling agent 3 is greater at the system inlet 4 than at the system outlet 5. In the example shown here, system inlet 4 is connected in parallel to exactly four components 2, so that system inlet 4 leads in parallel to four component inlets 6. In contrast, system outlet 5 in the example shown is connected to exactly one component outlet 7. As a result, the number of components 2 connected in parallel at the system inlet 4 in the example is four, while the number of components 2 fluidically connected in parallel with regard to the temperature-controlling agent 3 at the system outlet 5 in the example is one. In this example, the number of components 2 connected in parallel at the system inlet 4 is four times greater than at the system outlet 5. This means that the number of components 2 fluidically connected in parallel with regard to the temperature-controlling agent 3 at the system inlet 4 is 1.5 to 5 times, in particular 1.5 to 4 times, namely exactly 4 times greater than at the system outlet 5. In another advantageous embodiment, which is not shown here, the number of components 2 connected in parallel at the system inlet 4 can be 2 to 3.5 times greater than at the system outlet 5.

If, as in the example shown, more than three components 2 are provided, at least two components 2 can be fluidically connected in series at the system outlet 5 with regard to the temperature-controlling agent 3. This means that the system outlet 5 is fluidically connected to only one component outlet 7. In the example shown in FIG. 2, four components 2 are fluidically connected in series and are fluidically connected to the system outlet 5 via the last component 2, i.e., the component 2 that is last to be supplied with the temperature-controlling agent 3 within the series. The components in question 2 are designated 10-1, 9-1, 8-1, and 7-1 in FIG. 2. In contrast, the components 2 connected in parallel with system inlet 4 are designated 1-1, 1-2, 1-3, and 1-4. These designations within components 2 define the position of the respective component 2 within the circuit diagram 8. The first digit, i.e., the digit before the hyphen “-,” indicates the ranking or serial number or sequence with respect to system inlet 4 of a series to which the respective component 2 belongs. The second digit, i.e., the digit after the hyphen “-,” identifies or individualizes the individual components 2 that are flowed through in parallel in the respective series. For example, in the first row, whose components 2 are designated 1-1, 1-2, 1-3, and 1-4, and in the second row, whose components 2 are designated 2-1, 2-2, 2-3, and 2-4, four components 2 are flowed through in parallel in each case. In contrast, in the third row, whose components 2 are designated 3-1 and 3-2, in the fourth row, whose components 2 are designated 4-1 and 4-2, in the fifth row, whose components 2 are designated 5-1 and 5-2, and in the sixth row, whose components 2 are designated 6-1 and 6-2, only two components 2 are flowed through in parallel in each case. In the seventh row, whose component 2 is designated 7-1, in the eighth row, whose component 2 is designated 8-1, in the ninth row, whose component 2 is designated 9-1, and in the tenth row, whose component 2 is designated 10-1, only a single component 2 is flowed through in each case, so that the number of components 2 flowed through in parallel is one.

The number of components 2 fluidically connected in parallel with regard to the temperature-controlling agent 3 only decreases from the system inlet 4 to the system outlet 5. In the example, the number of system inlet 4 is four and the number of system outlet 5 is one, wherein within the temperature-controlling system 1, the number initially decreases from four in the first and second rows to two in the third to sixth rows and then from two to one in the seventh to tenth rows.

Several components 2 fluidically connected in parallel with regard to the temperature-controlling agent 3 form a parallel group 9. In the example shown in FIG. 2, six such parallel groups 9 are provided, namely the first to sixth rows. The first parallel group 9 therefore comprises components 2 with the designations 1-1, 1-2, 1-3, and 1-4. The second parallel group 9, through which the temperature-controlling agent 3 then flows, comprises the components 2 with the designations 2-1, 2-2, 2-3, and 2-4. This means that the first two parallel groups 9 each have four components 2 connected in parallel and form identical parallel groups 9. The following four parallel groups 9, i.e., the third to sixth parallel groups 9, each have only two components 2 connected in parallel. The third parallel group 9, through which the temperature-controlling agent 3 flows after the second parallel group 9, comprises the components 2 with the designations 3-1 and 3-2. The fourth parallel group 9, through which the temperature-controlling agent 3 then flows, has the two components 2 with the designations 4-1 and 4-2. After that, the fifth parallel group 9 is flowed through by the temperature-controlling agent 3, which has the two components 2 with the designations 5-1and 5-2. This is followed by the sixth parallel group 9, whose components 2 are labeled 6-1 and 6-2. The last parallel group 9 is followed by a series group 10, in which several components 2 connected in series follow one another. In the example shown in FIG. 2, series group 10 contains exactly four components 2, namely components 2 with the designations 7-1, 8-1, 9-1, and 10-1, which are successively flowed through by temperature-controlling agent 3 according to their ordinal number. These are the seventh to tenth rows mentioned above, each with only one component 2.

At least two parallel groups 9 are thus connected in series. In the example shown in FIG. 2, the first six parallel groups 9 are connected in series. In addition, at least two identical parallel groups 9 are fluidically connected in series. In the example shown in FIG. 2, two identical parallel groups 9, each containing exactly four components 2, are initially connected in series with each other. The first parallel group 9 is connected to the system inlet 4, while the second parallel group 9 is connected to the first parallel group 9. This is followed by four identical parallel groups 9, each containing exactly two components 2 and connected in series with each other. When two identical parallel groups 9 are connected in series, one component outlet 7 of the upstream parallel group 9 is fluidically connected to one component inlet 6 of the downstream parallel group 9. During the transition from the second parallel group 9, which contains four components 2, to the third parallel group 9, which now contains only two components 2, two component outlets 7 of the upstream second parallel group 9 are fluidically connected to a component inlet 6 of the downstream third parallel component 9. At the transition from the sixth and last parallel group 9 to series group 10, the two component outlets 7 of the two components 2 of the upstream sixth or last parallel group 9 are fluidically connected to the component inlet 6 of the component 2 of the seventh series or the first component 2 within series group 10, here with component 2, which bears the designation 7-1. Its component outlet 7 is then fluidically connected to the component inlet 6 of the subsequent component 2, which is designated 8-1 here. The next component 2 of series group 10, designated 9-1, is connected with its component inlet 6 to the component outlet 7 of the preceding component 2, designated 8-1, and with its component outlet 7 to the component inlet 6 of the next component 2, designated 10-1. The last component 2 of series group 10 with the designation 10-1 is then fluidically connected with its component outlet 7 to the system outlet 5. The fluidic connections between the component outlets 7 of upstream components 2 and the component inlets 6 of downstream components 2 are symbolically indicated in FIG. 2 by lines 12.

The temperature-controlling system 1 can comprise a system housing 11, which is indicated by a dashed line in FIG. 1. The system housing 11 has the system inlet 4 and the system outlet 5. The components 2 are arranged in the system housing 11. The system housing 11 may optionally feature a channel system 13, which is simplified in FIG. 2 and indicated by the lines 12, which serves to guide the temperature-controlling agent 3 and fluidically connects the system inlet 4 to the system outlet 5. The channel system 13 is configured to fluidically connect the component inlets 6 and the component outlets 7 to each other in accordance with the circuit diagram 8. For this purpose, the channel system 13 may have several connection points 14 that are configured to fluidically connect to the component inlets 6 and the component outlets 7. Conveniently, the connection points 14, the component inlets 6, and the component outlets 7 can now be coordinated with each other in such a way that they form plug connections. The plug connections are configured in such a way that the fluidic connections between the connection points 14 and the component inlets 6 or the component outlets 7 are established by plugging the component inlets 6 and the component outlets 7 into the connection points 14. These plug connections are easy to create and configure to be leak-proof, for example, using O-ring seals.

The components 2 can, for example, be battery modules 15, each of which has several electrochemical battery cells 16. The temperature-controlling system 1 can then form a temperature-controlled battery system 19 and, in particular, a temperature-controlled traction battery 20. According to the examples shown here, the battery module 15 can each have a temperature control plate 17 through which the temperature-controlling agent 3 can flow, which has the respective component inlet 6 and the respective component outlet 7 and which is connected to the battery cells 16 in a heat-transferring manner. FIG. 2 shows only the temperature control plates 17, which are connected fluidically to each other in accordance with the circuit diagram 8, in particular with the aid of the channel system 13, as representative of the battery modules 15. Alternatively, an embodiment is also conceivable in which the respective battery module 15 according to FIG. 1 has a module housing 18 through which the temperature-controlling agent can flow, which has the respective component inlet 6 and the respective component outlet 7 and in which the battery cells 16 are arranged in such a way that the battery cells 16 come into direct contact with the temperature-controlling agent 3.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining”or “in response to detecting,”depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

All matter contained in the above description or shown in the accompanying drawings shall be interpreted as illustrative only and not limiting. Changes in detail or structure may be made without departing from the present disclosure.

What is claimed is:

1. A temperature-controlling system for controlling a temperature of at least three components via a temperature-controlling agent, comprising:
a system inlet for supplying the temperature-controlling agent to the temperature-controlling system,
a system outlet for discharging the temperature-controlling agent from the temperature-controlling system,
at least three components to be temperature-controlled,
wherein each of the at least three components has a component inlet for supplying the temperature-controlling agent to the respective component,
wherein each of the at least three components has a component outlet for discharging the temperature-controlling agent from the respective component,
wherein the system inlet is fluidically connected to at least two component inlets,
wherein the system outlet is fluidically connected to at least one component outlet, and
wherein, within the temperature-controlling system, the at least three components are fluidically interconnected according to a circuit diagram such that a number of components fluidically connected in parallel with regard to the temperature-controlling agent is greater at the system inlet than at the system outlet.

2. The temperature-controlling system according to claim 1, wherein the number of components fluidically connected in parallel with regard to the temperature-controlling agent at the system inlet is 1.5 to 5 times greater than at the system outlet.

3. The temperature-controlling system according to claim 2, wherein the number of components fluidically connected in parallel with regard to the temperature-controlling agent at the system inlet is 1.5 to 4 times greater than at the system outlet.

4. The temperature-controlling system according to claim 3, wherein the number of components fluidically connected in parallel with regard to the temperature-controlling agent at the system inlet is 2 to 3.5 times greater than at the system outlet.

5. The temperature-controlling system according to claim 1, wherein:
the at least three components includes four or more components to be temperature-controlled,
at least two components are fluidically connected with regard to the temperature-controlling agent at the system outlet, and
the system outlet is fluidically connected to only one component outlet.

6. The temperature-controlling system according to claim 1, wherein the number of components fluidically connected in parallel with regard to the temperature-controlling agent does not increase or only decreases from the system inlet to the system outlet.

7. The temperature-controlling system according to claim 1, wherein:
several components of the at least three components fluidically connected in parallel with regard to the temperature-controlling agent form a parallel group, and
at least two parallel groups are connected in series.

8. The temperature-controlling system according to claim 7, wherein at least two identical parallel groups, in which the number of components fluidically connected in parallel with regard to the temperature-controlling agent is the same, are fluidically connected in series with regard to the temperature-controlling agent.

9. The temperature-controlling system according to claim 7, wherein:
at least two unequal parallel groups, in which the number of components fluidically connected in parallel with regard to the temperature-controlling agent differs, are fluidically connected in series with regard to the temperature-controlling agent, and
in an upstream parallel group of the at least two unequal parallel groups, the number of components fluidically connected in parallel with regard to the temperature-controlling agent is greater than in a downstream parallel group of the at least two unequal parallel groups.

10. The temperature-controlling system according to claim 7, wherein:
the system inlet is fluidically connected to one of the parallel groups,
the system outlet is fluidically connected to a series group in which several of the components of the at least three components are fluidically connected in series with regard to the temperature-controlling agent.

11. The temperature-controlling system according to claim 1, further comprising a system housing that has the system inlet and the system outlet and in which the at least three components are arranged,
wherein the system housing has a channel system that fluidically connects the system inlet to the system outlet for guiding the temperature-controlling agent, the channel system fluidically connects the component inlets and the component outlets to each other in accordance with the circuit diagram.

12. The temperature-controlling system according to claim 11, wherein:
the channel system has several connection points for fluidic connection to the component inlets and the component outlets, and
the connection points, the component inlets, and the component outlets are coordinated with each other such that they form plug connections, so that by plugging the component inlets and the component outlets with the connection points, the fluidic connections between the connection points and the component inlets and the component outlets are established.

13. The temperature-controlling system according to claim 1, wherein the respective component is a battery module comprising a plurality of electrochemical battery cells.

14. The temperature-controlling system according to claim 13, wherein the respective battery module has a temperature control plate through which the temperature-controlling agent can flow, the temperature control plate having the respective component inlet and the respective component outlet and to which the plurality of battery cells are connected for heat transfer.

15. The temperature-controlling system according to claim 13, wherein the respective battery module has a module housing through which the temperature-controlling agent can flow, the module housing having the respective component inlet and the respective component outlet and in which the plurality of battery cells are arranged such that they come into direct contact with the temperature-controlling agent.

16. A temperature-controlling system, comprising:
a system inlet for supplying a temperature-controlling agent to the temperature-controlling system,
a system outlet for discharging the temperature-controlling agent from the temperature-controlling system,
at least three components to be temperature-controlled,
wherein each of the at least three components has a component inlet for supplying the temperature-controlling agent to the respective component,
wherein each of the at least three components has a component outlet for discharging the temperature-controlling agent from the respective component,
wherein the system inlet is fluidically connected to at least two component inlets,
wherein the system outlet is fluidically connected to at least one component outlet, and
wherein, within the temperature-controlling system, the at least three components are fluidically interconnected according to a circuit diagram such that a number of components fluidically connected in parallel with regard to the temperature-controlling agent is greater at the system inlet than at the system outlet.

17. The temperature-control system according to claim 16, wherein the number of components fluidically connected in parallel with regard to the temperature-controlling agent at the system inlet is 1.5 to 5 times greater than at the system outlet.

18. The temperature-control system according to claim 16, wherein:
the at least three components includes four or more components to be temperature-controlled,
at least two components are fluidically connected with regard to the temperature-controlling agent at the system outlet, and
the system outlet is fluidically connected to only one component outlet.

19. The temperature-control system according to claim 16, wherein the number of components fluidically connected in parallel with regard to the temperature-controlling agent does not increase or only decreases from the system inlet to the system outlet.

20. The temperature-control system according to claim 16, wherein:
several components of the at least three components fluidically connected in parallel with regard to the temperature-controlling agent form a parallel group, and
at least two parallel groups are connected in series.
